(19) United States
(12) Patent Application Publication
(10) Pub. No.: US 2013/0071167 A1
(43) Pub. Date: Mar. 21, 2013

(54) IMAGE FORMING APPARATUS

(71) Applicants: Hideki Nakamura, Tokyo (JP); Akira Okamoto, Tokyo (JP); Akifume Isobe, Saitama (JP); Hiroyuki Futami, Tokyo (JP); Kenji Yamamoto, Tokyo (JP); Katsuyuki Ikuta, Shizuoka (JP)

(72) Inventors: Hideki Nakamura, Tokyo (JP); Akira Okamoto, Tokyo (JP); Akifume Isobe, Saitama (JP); Hiroyuki Futami, Tokyo (JP); Kenji Yamamoto, Tokyo (JP); Katsuyuki Ikuta, Shizuoka (JP)

(73) Assignee: KONICA MINOLTA BUSINESS TECHNOLOGIES, INC., Tokyo (JP)

(21) Appl. No.: 13/617,970

(22) Filed: Sep. 14, 2012

(30) Foreign Application Priority Data
Sep. 20, 2011 (JP) 2011-204207

(51) Int. Cl. G03G 15/00

(52) U.S. Cl. 399/381

(57) ABSTRACT

An image forming apparatus contains a first printer forming a first image on a surface of the sheet member, a reversing section reversing a surface of the sheet member and a second printer forming a second image on a back of the sheet member. The second printer contains a correction section correcting a deflection of the sheet member. A straight sheet-member-transporting path extends from the reversing section to the second printer. A distance between a position at which the sheet member enters the sheet-member-transporting path and a position at which the correction section corrects the deflection of the sheet member is set so as to be not smaller than a length of the sheet member having the largest size among the sheet members to be handled.

### CROSS REFERENCE TO RELATED APPLICATION

The present invention is based on Japanese Patent Application No. 2011-204207 filed with Japanese Patent Office on Sep. 20, 2011, the entire contents of which being hereby incorporated by reference.

### BACKGROUND OF THE INVENTION

1. Field of the Invention

The present invention relates to an image forming apparatus that is provided with an upstream printer, a downstream printer and a sheet-reversing section therebetween and which is applicable to a color printer, a color copy machine, a multiple function machine and the like.

2. Background of the Invention

Plural color printers connected in tandem and in series to carryout the duplex printing have been often used in a commercial printing art in recent years. For example, a printer of an upstream side forms a color image on one surface of a sheet member having a predetermined length; a sheet-reversing device provided between the printer of the upstream side and a printer of a downstream side reverses the surface of the sheet member on which the color image has been formed; and the printer of the downstream side forms another color image on the other surface of the sheet member.

Each color printer is provided with an image forming section of, for example, electrophotographic system, that converts image data of red (R), green (G) and blue (B) to image data for yellow (Y), magenta (M), cyan (C) and black (BK) in its image-forming section. The image forming section then forms toner images based on the converted image data for YMCK colors. The image forming section contains image forming units each having image forming output functions for each of the YMCK colors. Charging portions charge static charges uniformly around the surface of photosensitive drums for every image color of Y, M, C and BK. Latent images are formed on the photosensitive drums based on the image data by optical writing units each using a polygon mirror.

Developing devices then develop the latent images for every image color. The image forming apparatus performs these charging, exposing and developing, overlaps the color toner images formed on the surfaces of the photosensitive drums on an intermediate transfer belt and transfers the overlapped color toner images to a sheet member by a transfer unit. A sheet-supplying unit transports the sheet member to the transfer unit. A fixing portion fixes the toner image transferred to the desired sheet member. Thus, the image forming apparatus forms the color image on the desired sheet member based on the image data. Such color printers are connected in tandem (in series) to perform duplex printing.

In connection with such an image forming apparatus having a tandem configuration, Japanese Patent Application Publication No. 2009-300703 has disclosed a printing apparatus. This printing apparatus is provided with plural printers which are connected in series. Sensors are installed after a fixing unit of a downstream printer. An upstream printer prints a predetermined pattern on a surface of a printing sheet at a predetermined timing. A downstream printer prints a predetermined pattern on a back of the same printing sheet. The sensors measure the predetermined patterns on both surfaces of the printing sheet. On the basis of the measurement result by the sensors, feedback control to maintain the optimum color reproducibility of the upstream printing device or/and the downstream printing device is performed.

Japanese Patent Application Publication No. 2007-137012 has disclosed a printing apparatus which is provided with plural print engines. The printing apparatus has an inspection mode. In the inspection mode, a sheet is delivered to an upstream print engine where an inspection chart is printed. That sheet is further delivered to a downstream print engine where an inspection chart is further printed on the same surface of the sheet. The inspection charts printed by the print engines are patterned not to overlap. Consequently, such print results of the inspection charts by both print engines are printed on the same surface. The print results are visually checked or read out at a reading section.

### SUMMARY OF THE INVENTION

However, the past printing apparatuses disclosed in Japanese Patent Application Publications No. 2009-300703 and No. 2007-137012 has following issues:

(1) The printing apparatuses such as the above-mentioned past printing apparatuses have often performed any registration correction processing at the downstream printer to set a position to be image-formed of the back of the sheet member when they form an image on the back of sheet member after the sheet member is fixed. For example, when hitting a forward end of the sheet member against the registration rollers in the downstream printer before the photosensitive drum thereof and forming a loop, the sheet member is again transported at a predetermined timing.

In this case, when a sheet-transporting path at an upstream side is curved, seen from the downstream printer, or a sheet-transporting speed in the sheet-reversing mechanism at the upstream side is reasonably different from a sheet-transporting speed in the printer at a downstream side, the sheet member is pulled tight or the formed loop is insufficiently released so that it is difficult to set a position to be image-formed of the back of the sheet suitably. In order to avoid such conditions, it may be necessary to perform any precise controls such as a synchronization of a sheet-transporting section in the sheet-reversing device at the upstream side with the sheet-transporting section in the printer at the downstream side.

(2) Particularly, in the image-forming apparatus, the image-forming system or the like in which plural printers are connected in tandem, a long sized sheet member may remain in the sheet-reversing device at the upstream side when performing the registration correction processing at the downstream printer. In order to avoid such conditions, the large-scale and/or complex printing apparatus is desired.

While the downstream printer performs any registration correction processing on a sheet member (hereinafter, also referred to as “sheet”), a next sheet member enters a sheet-transporting path in which the sheet member during the registration correction processing stays remained so that the sheet members are contacted to each other. This hinders registration correction processing. In order to avoid this condition, if delaying the time when the next sheet member enters the sheet-transporting path, productivity deteriorates.

This invention solves the above-mentioned issues and it is desirable to provide an image forming apparatus that forms images on both surfaces of the sheet using printers at an upstream side and a downstream side, by which the sheet member on which the image has been formed can be successfully transported without any stresses into the printer at the downstream side and a productivity can be prevented from deteriorating.

To solve at least one of the above-mentioned issues, an image forming apparatus reflecting one aspect of the present invention contains a first image forming section which forms a first image on a first surface of the sheet member, a reversing section which reverses a surface of the sheet member on which the first image has been formed, the sheet member being ejected from the first image forming section, a second image forming section which forms a second image on a second surface of the sheet member reversed by the reversing section, a sheet-member-transporting path on which the sheet member, a surface of which is reversed, is transported from the reversing section to the second image forming section, and a correction section which corrects a deflection of the sheet member before the second image is formed in the second image forming section, the correction section being positioned on the sheet-member-transporting path, wherein a distance between a position at which the sheet member enters the sheet-member-transporting path and a position at which the correction section corrects the deflection of the sheet member on the sheet-member-transporting path is set so as to be not smaller than a length of the sheet member on a transporting direction thereof, the sheet member having the largest size among the sheet members to be handled in the image forming apparatus.

Further, it is desirable to provide the image forming apparatus wherein the sheet-member-transporting path is formed in a straight line.

It is also desirable to provide the image forming apparatus wherein the first image forming section, the reversing section and the second image forming section are arranged in a straight line.

It is further desirable to provide the image forming apparatus wherein the reversing section reverses a surface of the sheet member ejected from the first image forming section without changing an orientation of a forward end of the sheet member.

It is additionally desirable to provide the image forming apparatus further containing transporting rollers which transport the sheet member to the second image forming section with the sheet member being nipped, the transporting rollers being positioned on the sheet-member-transporting path, and a control section which controls an operation of the transporting rollers, wherein when the correction section corrects the deflection of the sheet member, the control section controls the operation of the transporting rollers to follow a correct operation of the correction section or to release the nipping of the sheet member by the transporting rollers.

The concluding portion of this specification particularly points out and directly claims the subject matter of the present invention. However, those skilled in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is a conceptual diagram of a duplex color printing apparatus as a first embodiment of this invention for showing a configuration example thereof;

FIG. 2 is a diagram of a processing unit and a fixing unit in a first or second printer for showing their configuration example thereof;

FIG. 3 is a perspective view of the duplex color printing apparatus, particularly, a sheet-reversing device and its surroundings, for showing the configuration example thereof;

FIG. 4 is a block diagram of a control section of the duplex color printing apparatus for illustrating a configuration example thereof;

FIGS. 5A and 5B are diagrams showing a registration correction processing example of a sheet member in the second printer, respectively seen from a front thereof and a top thereof;

FIGS. 6A and 6B are diagrams showing a registration fluctuation processing example of the sheet member in the second printer, respectively seen from a front thereof and a top thereof;

FIG. 7 is a conceptual diagram of a duplex color printing apparatus as a second embodiment of this invention for showing a configuration example thereof;

FIG. 8 is a conceptual diagram of a duplex color printing apparatus as a third embodiment of this invention for showing a configuration example thereof; and

FIG. 9 is a conceptual diagram of a duplex color printing apparatus as a fourth embodiment of this invention for showing a configuration example thereof.

### DESCRIPTION OF THE PREFERRED EMBODIMENTS

The following will describe embodiments of an image forming apparatus relating to the invention with reference to drawings. It is to be noted that the following description of the embodiments does not limit claims, which will be described later, or a meaning of each term thereof. These embodiments relate to a technology for making registration performance steady on the sheet member in the downstream printer when the sheet member is transported into the downstream printer after a surface of the sheet member ejected from the upstream printer has been reversed.

### First Embodiment

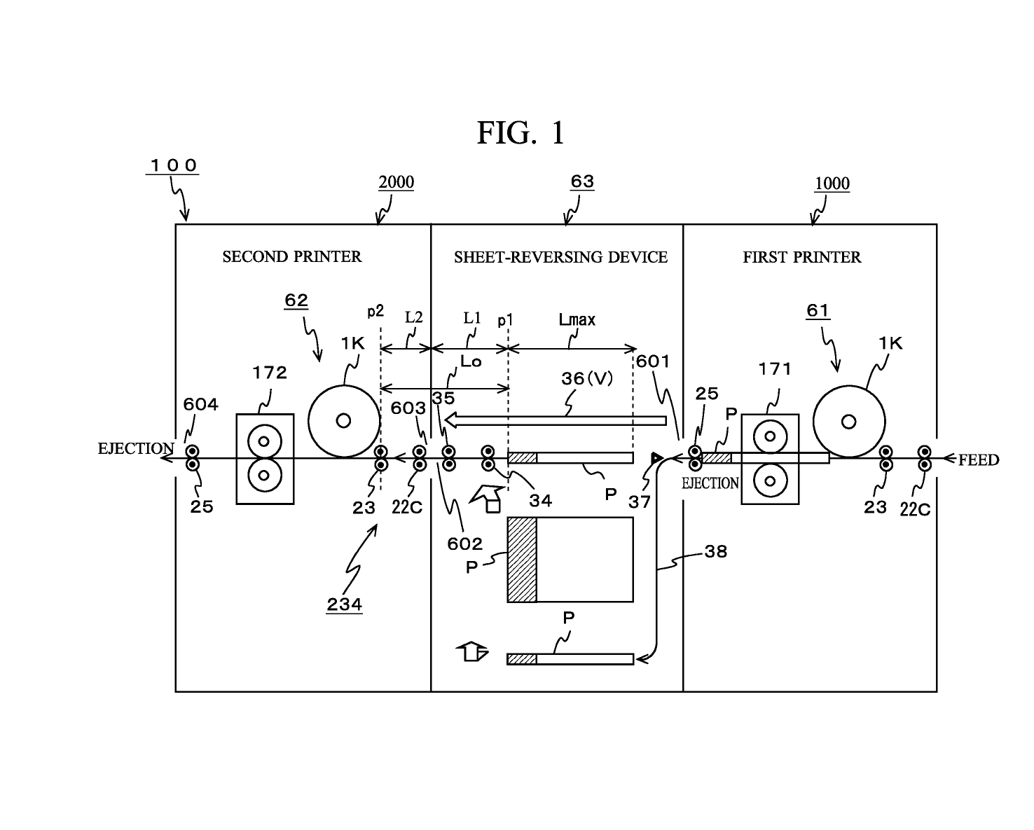

The following will describe a configuration example of a duplex color printer 100 as a first embodiment of this invention. The duplex color printer 100 as shown in FIG. 1 constitutes an image forming apparatus and forms an image on one surface of a sheet member having a predetermined length and then, reverses the surface thereof and forms another image on the other surface of the sheet member. The duplex color printer 100 is configured to have a first printer 1000, a sheet-reversing device 63 and a second printer 2000. The first printer 1000, the sheet-reversing device 63 and the second printer 2000 are arranged in line. Such an arrangement of them in line improves productivity in duplex printing because the first printer 1000 forms an image on the surface of the sheet member and the second printer forms an image on the back of the sheet member so that the images can be formed on both surfaces of the sheet members transported one after another.

The first printer 1000 (upstream printer) constitutes a first image forming section and is arranged at an upstream side of the sheet-reversing device 63. The first printer 1000 forms an image on a first surface (hereinafter, also referred to as “A-surface”) of the sheet member having a predetermined length. The sheet member includes plain paper, thick paper, thin paper, coated paper and plastic sheet.

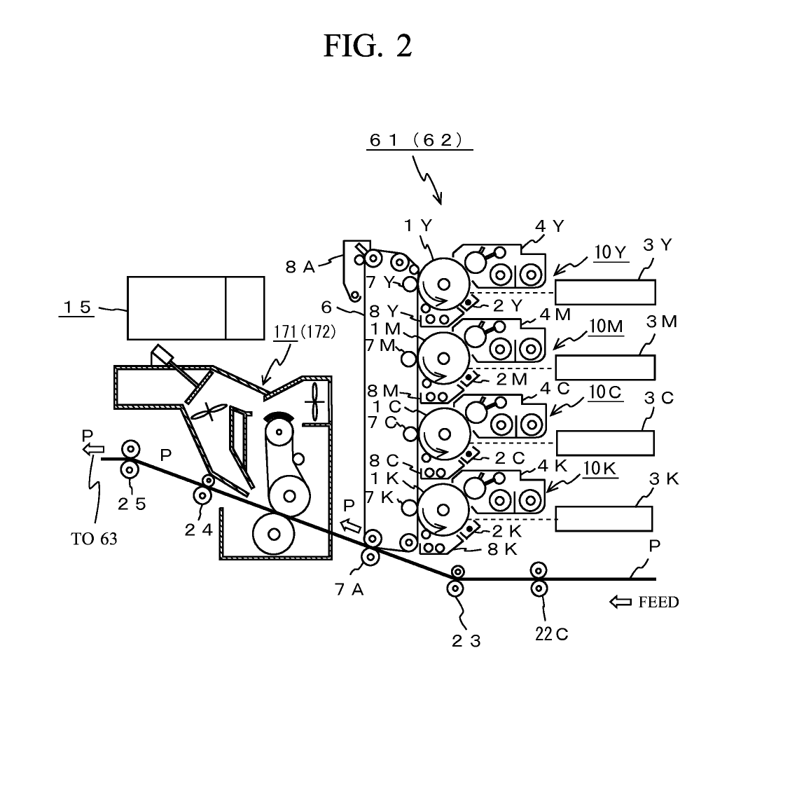

The first printer 1000 is configured to have a processing unit 61, a fixing unit 171, loop rollers 22C, registration rollers 23 and sheet ejection rollers 25. In the drawing, regarding the processing unit 61, only a photosensitive drum 1k for black color is illustrated. For the processing unit 61, for example, a printer engine of electrophotographic system, which is shown in FIG. 2, is used.

The processing unit 61 shown in FIG. 2 forms toner images having desired densities on an intermediate belt 6 having a belt surface and running at a predetermined speed. The processing unit 61 is configured to have an image forming unit 10Y which forms an yellow image (Y), an image forming unit 10M which forms a magenta image (M), an image forming unit 10C which forms a cyan image (C) and an image forming unit 10K which forms a black image (K). In this embodiment, the common functions concerning colors are indicated by Y, M, C and K, which respectively show colors to be formed, following a number, for example, 10.

The image forming unit 10Y contains a photosensitive drum 1Y, a charging portion 2Y which is arranged around the photosensitive drum 1Y, an optical writing unit 3Y, a developing unit 4Y and a cleaning portion 8Y.

The image forming unit 10M contains a photosensitive drum 1M, a charging portion 2M which is arranged around the photosensitive drum 1M, an optical writing unit 3M, a developing unit 4M and a cleaning portion 8M.

The image forming unit 10C contains a photosensitive drum 1C, a charging portion 2C which is arranged around the photosensitive drum 1C, an optical writing unit 3C, a developing unit 4C and a cleaning portion 8C.

The image forming unit 10K contains a photosensitive drum 1K, a charging portion 2K which is arranged around the photosensitive drum 1K, an optical writing unit 3K, a developing unit 4K and a cleaning portion 8K.

The respective photosensitive drums 1Y, 1M, 1C and 1K, the charging portions 2Y, 2M, 2C and 2K, the optical writing units 3Y, 3M, 3C and 3K, the developing units 4Y, 4M, 4C and 4K and the cleaning portions 8Y, 8M, 8C and 8K in the image forming units 10Y, 10M, 10C and 10K have the respectively common configurations. They will be described with Y, M, C and K being omitted except for any cases in which they are required to be distinguished.

In the image forming units 10, the charging portions 2 charge a static charge uniformly around surfaces of the photosensitive drums 1. Each of the optical writing units 3 is composed of, for example, a laser scanning exposure device of polygon mirror type. The optical writing units 3 scan the surfaces of the photosensitive drums 1 using laser beam based on the image data of each image color and operate so as to write the image data on the surfaces of the photosensitive drums 1 for every line. On the photosensitive drums 1, latent images are respectively formed by the laser beam scanned using polygon mirrors. The developing units 4 develop the latent images formed on the surfaces of the photosensitive drums 1 by using toners. This enables toner images, which are visual images, to be formed on the photosensitive drums 1.

In the processing unit 61, the yellow image (Y), the magenta image (M), the cyan image (C) and the black image (K) are respectively formed on the photosensitive drums 1Y, 1M, 1C and 1K of the image forming units 10Y, 10M, 10C and 10K. The toner images of respective colors formed on the photosensitive drums 1Y, 1M, 1C and 1K are transferred to the intermediate transfer belt 6 by driving primary transfer rollers 7Y, 7M, 7C and 7K corresponding to the photosensitive drums 1 of respective colors Y, M, C and K (primary transfer).

The intermediate transfer belt 6 has an endless belt. The photosensitive drums 1Y, 1M, 1C and 1K respectively transfer the toner images to the intermediate transfer belt 6. The intermediate transfer belt 6 is stretched across plural rollers so as to be able to run around them. By moving the intermediate transfer belt 6 on a clockwise direction, the color images formed on the intermediate transfer belt 6 are transported toward a secondary transfer portion 7A. The secondary transfer portion 7A is arranged below the processing unit 61 and at the lowest position of the intermediate transfer belt 6.

A feeder unit, not shown, is connected to the processing unit 61 and feeds a sheet P to the processing unit 61. The feeder unit contains feeding trays storing plain paper, thin paper, thick paper and coated paper of predetermined sizes and a large capacity paper feeder unit (PFU). The sheet P is transported to the secondary transfer portion 7A through the loop rollers 22C and the registration rollers 23.

The secondary transfer portion 7A transfers the toner images formed on the intermediate transfer belt 6 all together from the intermediate transfer belt 6 to the sheet P (secondary transfer). The fixing unit 171 (172) is positioned at a downstream side of the secondary transfer portion 7A and performs fixing processing on the sheet P on which the color image is transferred. The fixed sheet P is ejected by the sheet ejection rollers 25 through fixing and transporting rollers 24 to the sheet-reversing device 63.

Corresponding to user's setting of an additional printing mode, a simplex printing mode or a duplex printing mode, this duplex color printer 100 additionally forms an image on the same surface of the fixed sheet P, ejects the fixed sheet P as it is, or forms an image on the back of the fixed sheet P.

The cleaning portions 8Y, 8M, 8C and 8K are provided at left low positions of the respective photosensitive drums 1 for yellow (Y), magenta (M), cyan (C) and black (K) so that they respectively correspond to the photosensitive drums 1Y, 1M, 1C and 1K. The cleaning portions 8Y, 8M, 8C and 8K remove (clean) any toner materials remained in the photosensitive drums 1Y, 1M, 1C and 1K after former optical writing has been carried out. A cleaning portion 8A is provided at a left upper portion of the intermediate transfer belt 6 and cleans any toner materials remained in the intermediate transfer belt 6 after the secondary transfer.

Further, the sheet-reversing device 63 shown in FIG. 1 is connected to the first printer 1000 in series at a downstream side of the first printer 1000. The sheet-reversing device 63 reverses a surface of the image-formed sheet P which is ejected from the first printer 1000. In this embodiment, the sheet-reversing device 63 is configured to use a same edge system. According to the same edge system, a surface of the image-formed sheet P which is ejected from the first printer 1000 is reversed by 180 degrees by transporting it following almost circular arcs each extending to a direction perpendicular to a transporting direction of the sheet P. In the same edge system, the sheet is not upside down, namely, any orientations of a forward end and a rear end of the sheet P are not changed. This enables the printers 1000, 2000 to form the images on the same sheet from a side of the forward end of the same sheet so that a position of the image on the surface of the sheet member meets a position of the image on the back of the sheet member, thereby allowing excellent image forming to be performed.

The sheet-reversing device 63 has a sheet-feeding inlet 601 and a sheet-ejection outlet 602. The sheet-reversing device 63 is provided with a sheet-transporting path in line (hereinafter, referred to as “straight transporting path 36”) extending from the sheet-feeding inlet 601 to the sheet-ejection outlet 602. The straight transporting path 36 is used when performing the additional printing mode.

The additional printing mode is referred to as a mode in which the first printer 1000 forms an image on a surface of the sheet P and then the second printer 2000 forms an image on the same surface of the sheet P. In this additional printing mode, the sheet P on which the first printer 1000 has formed the image is sent to the second printer 2000 through the sheet-reversing device 63 without reversing the surface of the sheet P.

The straight transporting path 36 includes a first linear sheet-transporting path L1. The first linear sheet-transporting path L1 linearly extends from a position p1 at which the reversed sheet P enters the first linear sheet-transporting path L1 to a position of a sheet-feeding inlet 603 of the second printer 2000 (the sheet-ejection outlet 602 of the sheet-reversing device 63). The position p1 is, for example, a position corresponding to a forward end of the sheet P, a surface of which has been reversed.

The maximum length Lmax of the sheet P is 420 mm when, for example, a size of the sheet P to be handled in the duplex color printer 100 is A3 size. The maximum length Lmax of the sheet P is 596 mm when it is A2 size.

The sheet-reversing device 63 has transporting rollers 34 and sheet ejection rollers 35. The transporting rollers 34 and the sheet ejection rollers 35 are positioned on the first linear sheet-transporting path L1 and transport the sheet P to the second printer 2000 with nipping the sheet P.

In this embodiment, a transporting-divergence portion 37 and a reverse-transporting path 38, which has a different transporting direction, in addition to the straight transporting path 36, are provided just behind the sheet-feeding inlet 601. The transporting-divergence portion 37 selects any one of the straight transporting path 36 and the reverse-transporting path 38 corresponding to the additional printing mode or the duplex printing mode to allow the sheet-transporting path to diverge. Here, the duplex printing mode is referred to as “an operation in which images are formed on both surfaces of the sheet P”.

The second printer 2000 (downstream printer) constitutes a second image forming section and is arranged at a downstream side of the sheet-reversing device 63. The second printer 2000 is connected to the sheet-reversing device 63 in series. The second printer 2000 has the sheet-feeding inlet 603 and a sheet-ejecting outlet 604 to receive the sheet P, a surface of which the sheet-reversing device 63 has been reversed, from the sheet-feeding inlet 603. The second printer 2000 then forms an image on a second surface (hereinafter, also referred to as “B-surface”) of the sheet member.

The second printer 2000 is configured to have a second linear sheet-transporting path L2. The second printer 2000 is also configured to have a processing unit 62 (see FIG. 2) including a photosensitive drum 1k, a fixing unit 172, loop rollers 22C, registration rollers 23 and sheet ejection rollers 25. The second linear sheet-transporting path L2 extends from a position of the sheet-feeding inlet 603 to an attached position p2 of the registration rollers 23 (a position in which deflection of the sheet P is corrected).

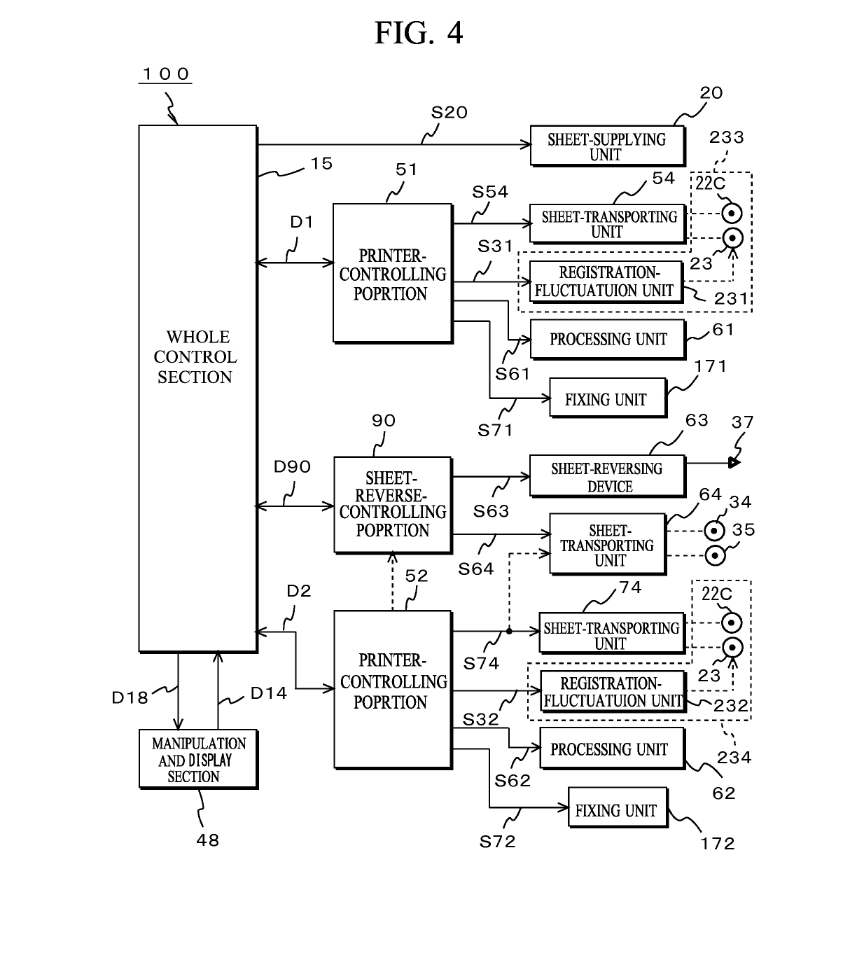

The loop rollers 22C and the registration rollers 23 are provided on the second linear sheet-transporting path L2 in the second printer 2000. The loop rollers 22C and the registration rollers 23 constitute a correction portion 234 for correcting a deflection of the sheet P on which an image has been formed (see FIG. 4). The loop rollers 22C and the registration rollers 23 transport the sheet P to a position under the processing unit 62. In this embodiment, the first linear sheet-transporting path L1 and the second linear sheet-transporting path L2 constitute a sheet-transporting path on which the sheet P is transported from the sheet-reversing device 63 to the second printer 2000. It is configured so that a distance Lo between a position p1 at which the sheet member enters the first linear sheet-transporting path L1 and a position p2 at which the correction section corrects the deflection of the sheet P is set so as to be not smaller than the maximum length Lmax of the sheet P on a transporting direction thereof, the sheet P having the largest size among the sheets to be handled in the duplex color printer 100.

It is because the sheet P can be not only easily delivered to the registration rollers 23 in the second printer 2000 without ant stresses but also the registration correction processing can become stable in the second printer 2000 to set the distance Lo so as to be not smaller than the maximum length Lmax of the sheet P having the largest size. Setting of the distance Lo so as to be not smaller than the maximum length Lmax is also because any precise control such as a synchronization of a sheet-reverse-controlling portion 90 of the sheet-reversing device 63 is unnecessary. Setting of the distance Lo so as to be not smaller than the maximum length Lmax is further because a next sheet P can enter the sheet-transporting path to the second printer 2000 from the sheet-reversing device 63 while the correction portion 234 corrects the deflection of the sheet P, which prevents the sheets P from stopping moving, so that the productivity can be improved.

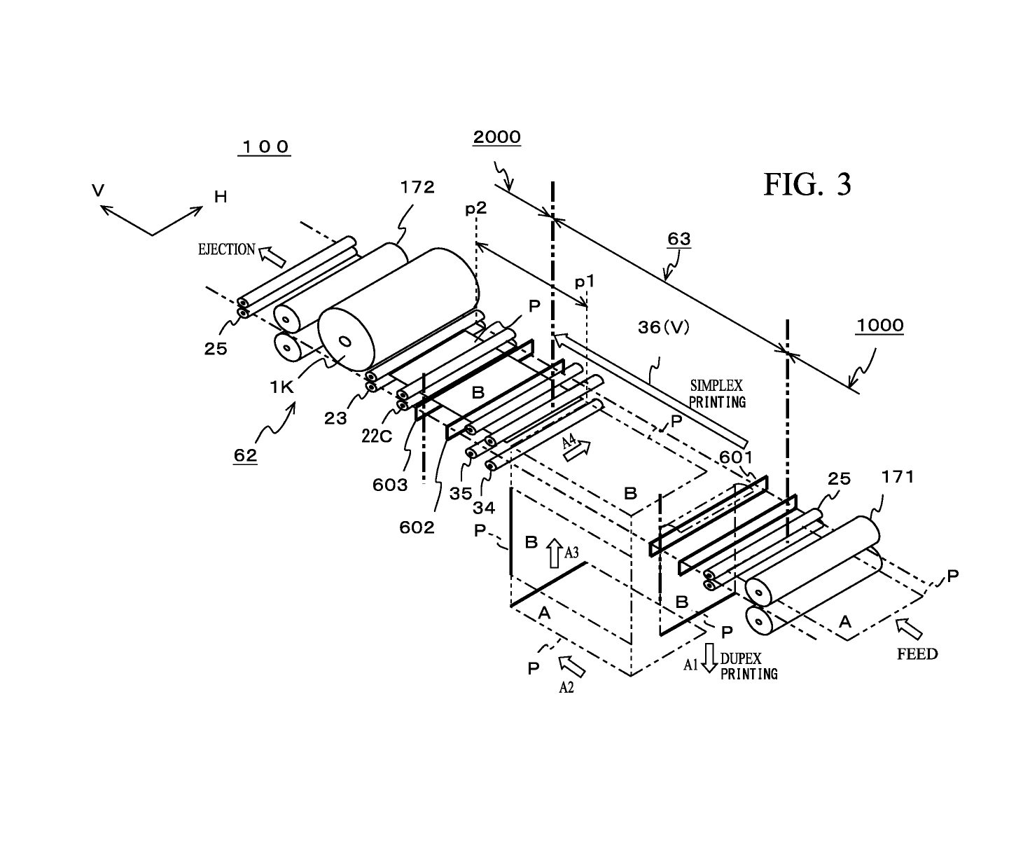

In the sheet-reversing device 63 of the same edge system in the duplex color printer 100 shown in FIG. 3, even if the surface of the sheet P is reversed, the forward end of the sheet P is hit against the registration rollers 23 in the second printer 2000. In FIG. 3, a symbol “V” indicates to the sheet-transporting direction and a direction perpendicular to a scanning direction of an image-forming section. A symbol “H” indicates to a direction perpendicular to the sheet-transporting direction and a scanning direction of the image-forming section. In the sheet-reversing device 63, the fixed sheet P ejected from the first printer 1000 is reversed by transporting it to a direction perpendicular to the sheet-transporting direction V following almost circular arcs. In other words, the sheet P on a first surface (A-surface) of which an image has been formed, falls down according to an arrow A1 shown in FIG. 3 with the forward end of the sheet P being directed to a bottom of the sheet-reversing device 63 when the sheet P is introduced into the sheet-feeding inlet 601 of the sheet-reversing device 63.

When the sheet P has completely fallen and been horizontally transported according to an arrow A2 shown in FIG. 3, the A-surface of the sheet P faces upward. The sheet P is then transported upward to a direction perpendicular to the sheet-transporting direction V following an almost circular arc according to an arrow A3 shown in FIG. 3 with a side end of the sheet P being at the front. The second surface (B-surface) of the sheet P faces to aside surface of the main body of the sheet-reversing device 63.

When the sheet P has completely transported upward, the sheet P is then transported horizontally to a direction perpendicular to the sheet-transporting direction V following an almost circular arc according to an arrow A4 shown in FIG. 3 with the side end of the sheet P being at the front. When the sheet P is horizontally transported, the B-surface of the sheet P faces upward.

Thus, in the same edge system, the sheet P is not upside down. Namely, any orientations of a leading edge and a rear edge of the sheet member are not changed. The sheet-reversing device 63 of the same edge system prevents the duplex color printer 100 from being large-sized in the width and vertical directions thereof.

The following will describe a configuration example of a control section of the duplex color printer 100 with reference to FIG. 4. The control section of the duplex color printer 100 shown in FIG. 4 is configured so as to contain a whole control section 15, a sheet-supplying unit 20, a manipulation and display section 48, printer-controlling portions 51, 52, and a sheet-reverse-controlling portion 90. The whole control section 15 is connected to the manipulation and display section 48. The manipulation and display section 48 is configured to have a touch panel and a liquid crystal display panel. For the manipulation and display section 48, any input means of graphic user interface (GUI) system is used. The manipulation and display section 48 is used when the additional printing mode, the duplex printing mode, the simplex printing mode or the like is selected.

Here, the simplex printing mode is referred to as an operation to form an image on a predetermined sheet P. When setting the simplex printing mode, the fixed sheet P is transported on the straight line on the straight transporting path 36 in the sheet-reversing device 63 from the first printer 1000 to the second printer 2000. In the duplex printing mode, the fixed sheet P is transported by the fixing and transporting rollers 24 to the sheet-reversing device 63 which reverses the surface thereof and then, the second printer 2000 forms an image on the back of the sheet P.

Of course, the manipulation and display section 48 is also used when selecting an image-forming condition and/or a sheet-supplying unit. For example, a user manipulates the manipulation and display section 48 to set an image-forming condition when selecting a species of the sheet P and/or a sheet size thereof, or selecting a sheet-feeding tray of the sheet-supplying unit in which the sheets P are stored. The manipulation and display section 48 converts the image-forming condition, sheet-feeding tray selecting information and/or the like set thereby to operation data D14 which is output to the whole control section 15. The manipulation and display section 48 displays the image-forming condition or the like on its display portion based on display data D18. The whole control section 15 outputs the display data D18 to the manipulation and display section 48.

The whole control section 15 is connected to the sheet-supplying unit 20. The whole control section 15 generates a sheet-supplying control signal S20 based on the image-forming condition set by the manipulation and display section 48, printing mode or the like. The sheet-supplying unit 20 receives the sheet-supplying control signal S20 based on the image-forming condition, printing mode or the like and supplies the sheet P to the first printer 1000 based on the sheet-supplying control signal S20. The whole control section 15 outputs the sheet-supplying control signal S20 to the sheet-supplying unit 20. For the sheet-supplying unit 20, plural sheet-feeding trays and/or the large capacity sheet feeder such as PFU are used.

The whole control section 15 is connected to the printer-controlling portion 51. The printer-controlling portion 51 controls the first printer 1000 shown in FIG. 1 based on printer control data D1. The whole control section 15 outputs the printer control data D1 to the printer-controlling portion 51. The printer-controlling portion 51 decodes the printer control data D1 to generate a registration-controlling signal S31, a transport-controlling signal S54, an image-forming signal S61 and a fixing-controlling signal S71.

The printer-controlling portion 51 is connected to a sheet-transporting unit 54, the processing unit 61, a fixing unit 171 and a registration-fluctuation unit 231. The sheet-transporting unit 54 transports the sheet P to a position under the processing unit 61 based on the transport-controlling signal S54. The printer-controlling portion 51 outputs the transport-controlling signal S54 to the sheet-transporting unit 54. The sheet-transporting unit 54 drives the loop rollers 22C, the registration rollers 23 and the sheet ejection rollers 25 in the first printer 1000 shown in FIG. 1, in addition to the transporting rollers, not shown.

The registration-fluctuation unit 231 performs registration-fluctuation processing on the sheet P based on the registration-controlling signal S31. The printer-controlling portion 51 outputs the registration-controlling signal S31 to the registration-fluctuation unit 231. The registration-fluctuation unit 231 and the loop rollers 22C, the registration rollers 23 and the like in the first printer 1000 constitute the correction section 233.

The processing unit 61 forms a color image on the sheet P based on the image-forming signal S61. The printer-controlling portion 51 outputs the image-forming signal S61 to the processing unit 61. The fixing unit 171 heats the sheet P on which the image is formed on the basis of the fixing-controlling signal S71 to fix toner image on the sheet P. The printer-controlling portion 51 outputs the fixing-controlling signal S71 to the fixing unit 171.

The sheet-reverse-controlling portion 90 constitutes a transport-controlling section and it is connected to the whole control section 15. The sheet-reverse-controlling portion 90 is also connected to the sheet-reversing device 63 and a sheet-transporting unit 64. The sheet-reverse-controlling portion 90 controls the sheet-reversing device 63 shown in FIG. 1 based on reverse control data D90. The whole control section 15 outputs the reverse control data D90 to the sheet-reverse-controlling portion 90. The sheet-reverse-controlling portion 90 decodes the reverse control data D90 to generate a reverse control signal S63 and a transport control signal S64.

The sheet-reversing device 63 reverses a surface of the sheet P based on the reverse control signal S63. For example, the sheet-reversing device 63 is connected to the transporting-divergence portion 37. The sheet-reversing device 63 controls the transporting-divergence portion 37 to select any one of the straight transporting path 36 and the reverse-transporting path 38 corresponding to the setting of additional printing mode, the simplex printing mode or the duplex printing mode so as to allow the sheet-transporting direction to diverge. The sheet-reverse-controlling portion 90 outputs the reverse control signal S63 to the sheet-reversing device 63. The sheet-transporting unit 64 transports the sheet P to the second printer 2000 based on the transport control signal S64. The sheet-reverse-controlling portion 90 outputs the transport control signal S64 to the sheet-transporting unit 64. The sheet-transporting unit 64 includes the transporting rollers 34 and the sheet ejection rollers 35, which have been shown in FIG. 1.

In this embodiment, the sheet-reverse-controlling portion 90 outputs the transport control signal S64 to the sheet-transporting unit 64 to control the transporting rollers 34 and the sheet ejection rollers 35 so that after the sheet P has been delivered to the loop roller 22C, the registration rollers 23 and the like in the second printer 2000, the transporting rollers 34 and the sheet ejection rollers 35 are driven based on the operation of the loop rollers 22C and the like or the transporting rollers 34 and the sheet ejection rollers 35 releases the nipping of sheet P. Such a control enables any precise control such as a synchronization of the transporting rollers 34 and the sheet ejection rollers 35 in the sheet-transporting unit 64 with the loop rollers 22C, the registration rollers 23 and the like in the second printer 2000 to be made unnecessary.

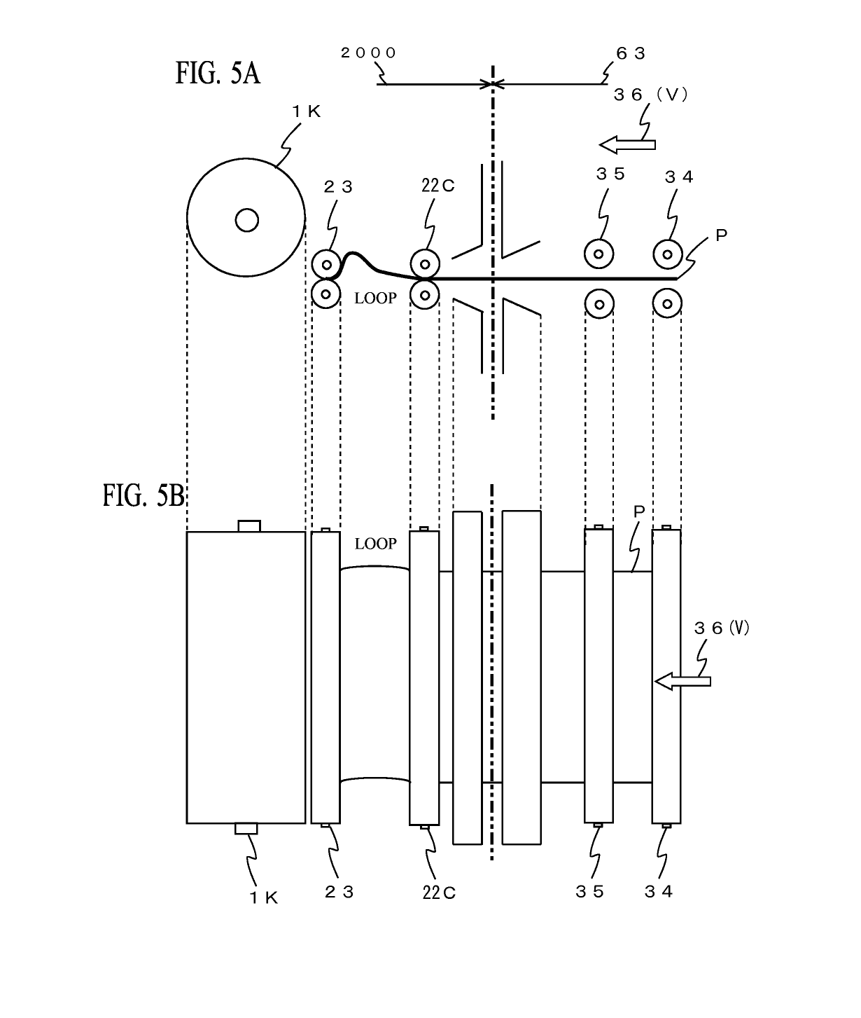

When the forward end of the sheet P is hit against the registration rollers 23 in the second printer 2000 to be nipped, the deflection (posture) of the sheet P is corrected so that the forward end of the sheet P meets a direction (the main scanning direction) perpendicular to the sheet-transporting direction (registration correction processing). The registration rollers 23 then rotate and the loop rollers 22C is opened (released) just after the registration rollers 23 nip the forward end of the sheet P so that the deflection decreases in accordance with the rear end of the sheet P as shown in FIG. 5B. This enables the deflection of the sheet P to be corrected by it.

When delivering the sheet P, the printer-controlling portion 52 may control the sheet-transporting unit 64 directly or may control the sheet-transporting unit 64 through the sheet-reverse-controlling portion 90 indirectly using paths shown by broken lines in FIG. 4. Such a control enables to be reduced any load in the control by the sheet-reverse-controlling portion 90.

The whole control section 15 is also connected to the printer-controlling portion 52. The printer-controlling portion 52 controls the second printer 2000 shown in FIG. 1 based on printer control data D2. The whole control section 15 outputs the printer control data D2 to the printer-controlling portion 52. The printer-controlling portion 52 decodes the printer control data D2 to generate a registration-controlling signal S32, an image-forming signal S62, a fixing-controlling signal S72 and a transport-controlling signal S74.

The printer-controlling portion 52 is connected to a sheet-transporting unit 74, the processing unit 62, a fixing unit 172 and a registration-fluctuation unit 232. The sheet-transporting unit 74 transports the sheet P to a position under the processing unit 62 based on the transport-controlling signal S74. The printer-controlling portion 52 outputs the transport-controlling signal S74 to the sheet-transporting unit 74. The sheet-transporting unit 74 includes the loop rollers 22C, the registration rollers 23 and the sheet ejection rollers 25 in the second printer 2000 shown in FIG. 1.

The registration-fluctuation unit 232 performs registration-fluctuation processing on the sheet P based on the registration-controlling signal S32. The printer-controlling portion 52 outputs the registration-controlling signal S32 to the registration-fluctuation unit 232. The registration-fluctuation unit 232 and the loop rollers 22C and the registration rollers 23 in the second printer 2000 constitute the correction section 234.

The processing unit 62 forms a color image on the sheet P based on the image-forming signal S62. The printer-controlling portion 52 outputs the image-forming signal S62 to the processing unit 62. The fixing unit 172 heats the sheet P on which the image is formed on the basis of the fixing-controlling signal S72 to fix a toner image on the sheet P. The printer-controlling portion 52 outputs the fixing-controlling signal S72 to the fixing unit 172. Thus, the control section of the duplex color printer 100 is configured.

The following will describe a registration correction processing example of a sheet P in the second printer 2000 with reference to FIGS. 5A and 5B. According to the registration correction processing example in the second printer 2000 shown in FIG. 5A, the registration rollers 23 are closed to each other and stop the rotation thereof as well as the transporting rollers 34 and the sheet ejection rollers 35 in the sheet-reversing device 63 are opened (released) so that their driven roller and driving roller, which are positioned at the upper and lower ends, are opened (released). In this condition, by rotating the loop rollers 22C, a forward end of the sheet p nipped by the loop rollers 22C is hit against the registration rollers 23 so as to form a loop. Such a loop is formed in a space between the registration rollers 23 and the loop rollers 22C.

This enables the deflection (posture) of the sheet P to be corrected by hitting the forward end of the sheet P against the registration rollers 23 so that the forward end of the sheet P meets a direction (the main scanning direction) perpendicular to the sheet-transporting direction (registration correction processing). The registration rollers 23 then rotate and the loop rollers 22C is opened (released) just after the registration rollers 23 nip the forward end of the sheet P so that the deflection decreases in accordance with the rear end of the sheet P shown in FIG. 5B. This enables the deflection of the sheet P to be corrected by it.

The forward end of the sheet P then keeps being parallel with the main scanning direction and in this condition, the loop rollers 22C and the sheet ejection rollers 35 nip the sheet P again. They transport the sheet P together with the registration rollers 23 to a position under the photosensitive drum 1K. This enables the registration correction processing to be performed on the sheet P without any stresses, even if the sheet is long.

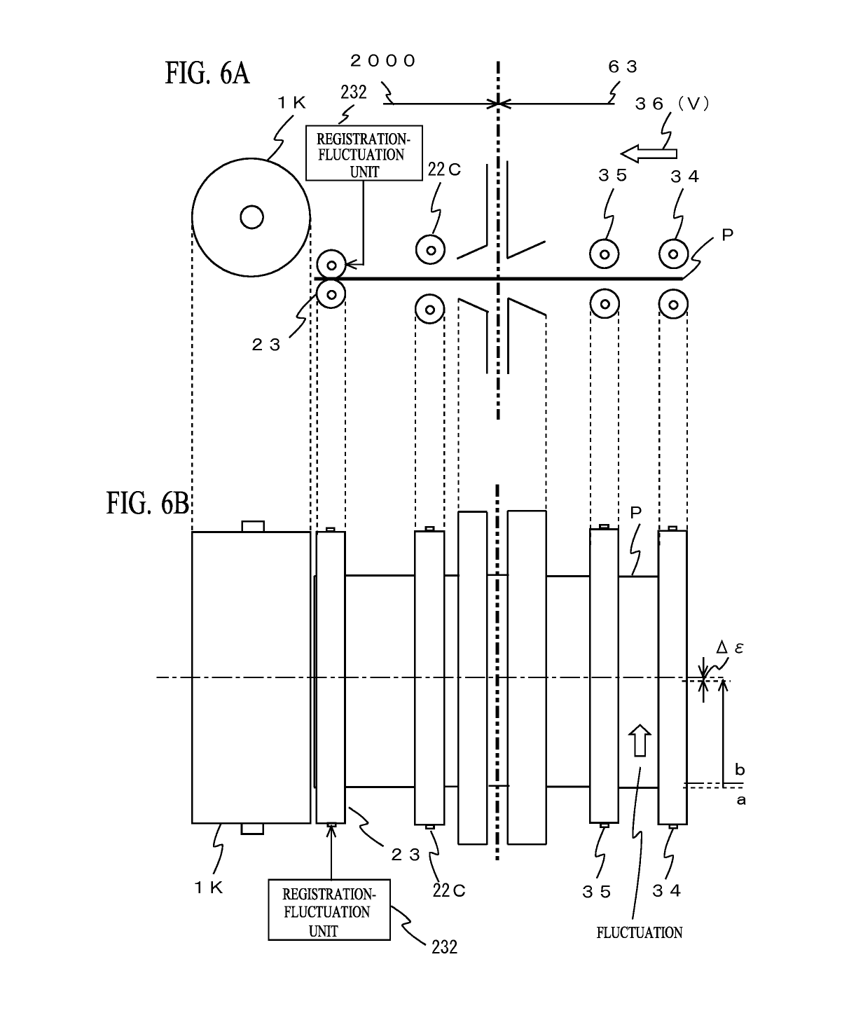

The following will describe a registration fluctuation processing example of a sheet P in the second printer 2000 with reference to FIGS. 6A and 6B. According to the registration fluctuation processing example in the second printer 2000 shown in FIG. 6A, the registration-fluctuation unit 232 is provided at a predetermined position in the registration rollers 23. In this embodiment, when an amount of deviation of the sheet P exceeds an acceptable limit, after the registration correction processing has been performed on the sheet P, the registration rollers 23 stop rotating just after the registration rollers 23 nip the forward end of the sheet P.

The registration-fluctuation unit 232 shifts the registration rollers 23 to the main scanning direction in a situation such that the loop rollers 22C, the sheet ejection rollers 35 and the transporting rollers 34 are opened (released), namely, the sheet P is free to shift to the main scanning direction without nipping the forward end of the sheet P by the registration rollers 23.

A shifted amount of the sheet P in this moment corresponds to an error which is obtained by subtracting an acceptable limit from an amount of deviation of the sheet P at the time of detecting the deviation thereof. The registration-fluctuation unit 232 shifts the registration rollers 23 to the main scanning direction by such an error as the amount of correction. The shift enables a center position of the sheet P held by the registration rollers 23 to meet a center position of the image which the image-forming section forms.

The loop rollers 22C and the sheet ejection rollers 35 nip the sheet P again while the center position of the sheet P meets the center position of the image which the image-forming section forms. They transport the sheet P together with the registration rollers 23 to a position under the photosensitive drum 1K. This enables the registration fluctuation processing to be performed on the sheet P without any stresses, even if the sheet is long.

Thus, according to the duplex color printer 100 as the first embodiment of this invention, the first printer 1000, the sheet-reversing device 63 and the second printer 2000 are connected in series and the sheet-reversing device 63 includes the first linear sheet-transporting path L1 extending from the position p1 at which the reversed sheet P enters the first linear sheet-transporting path L1 to the position of the sheet-feeding inlet 603 of the second printer 2000.

The second printer 2000 has the correction portion 234 for correcting a deflection of the sheet P on which an image has been formed. The second printer 2000 includes the second linear sheet-transporting path L2 extending from the position of the sheet-feeding inlet 603 to the position p2 at which the deflection of the sheet P is corrected. On the assumption of this, the distance Lo between the positions p1 and p2 is set to be not smaller than the maximum length Lmax of the sheet P on a transporting direction thereof, the sheet P having the largest size among the sheets to be handled in the duplex color printer 100.

such a configuration enables not only the sheet P to be delivered to the correction portion 234 in the second printer 2000 without any stresses but also the registration correction processing to be stable in the second printer 2000. Such a configuration also enables any precise control such as a synchronization of the transporting rollers 34 and the sheet ejection rollers 35 in the first printer 1000 when performing the registration correction processing to be made unnecessary. Such a configuration further enables a next sheet P to enter the sheet-transporting path to the second printer 2000 from the sheet-reversing device 63 while the correction portion 234 corrects the deflection of the sheet P, which prevents the sheets P from stopping moving, so that the productivity can be improved.

Further, according to the registration fluctuation processing, it is possible to shift the sheet P to the main scanning direction perpendicular to the sheet-transporting direction without any stresses to the sheet P. This prevents the duplex color printer 100 from being large-sized in the width and vertical directions thereof.

### Second Embodiment

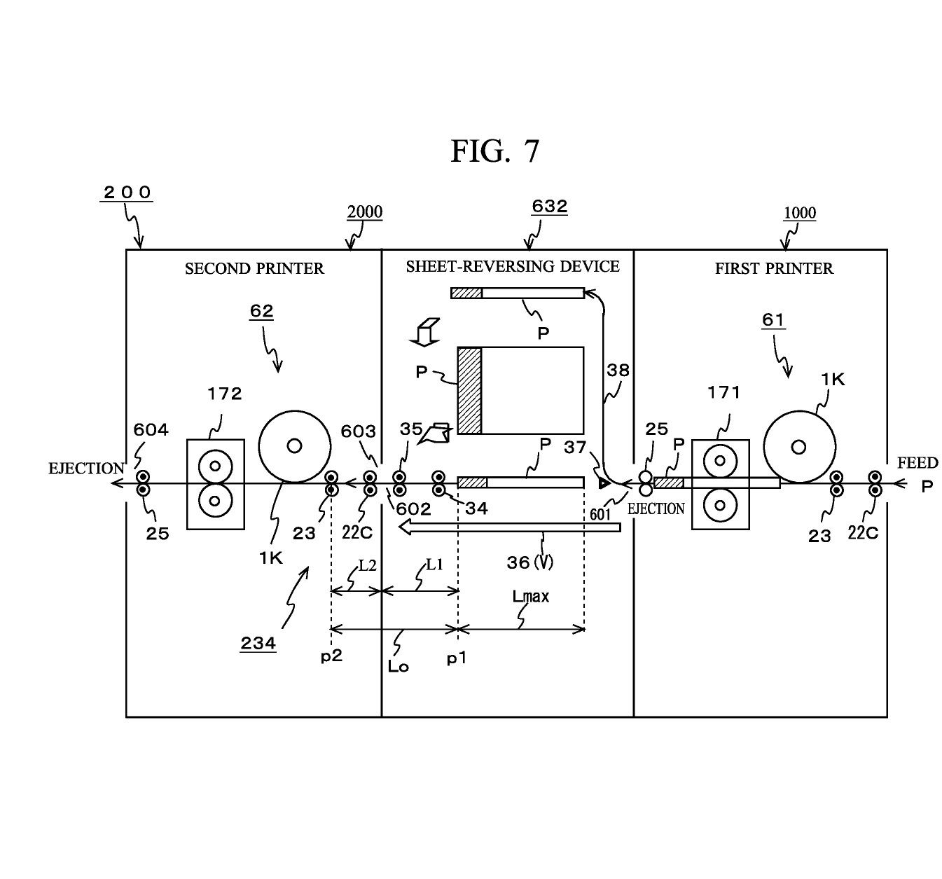

The following will describe a configuration example of a duplex color printer 200 according to a second embodiment of this invention with reference to FIG. 7. The second embodiment is different from the first embodiment in that a sheet-reversing device 632 of the same edge system is provided above the straight transporting path 36 wherein the surface of the sheet P is reversed but the sheet P is not upside down, namely, an orientation of the forward end of the sheet P is not changed. Accordingly, the forward end of the sheet P is hit against the registration rollers 23 in the second printer 2000.

In this second embodiment, according to the sheet-reversing device 632 shown in FIG. 7, the fixed sheet P ejected from the first printer 1000 is reversed by transporting it to a direction perpendicular to the sheet-transporting direction V following almost circular arcs. In other words, the sheet P on a first surface of which an image has been formed, rises upward with the forward end of the sheet P being directed to a top of the sheet-reversing device 632 when the sheet P is introduced into the sheet-feeding inlet 601 of the sheet-reversing device 632.

When the sheet P has completely risen and been horizontally transported, the first surface of the sheet P faces upward. The sheet P is then transported downward to a direction perpendicular to the sheet-transporting direction V following an almost circular arc with a side end of the sheet P being at the front. The first surface of the sheet P faces to a side surface of the main body of the sheet-reversing device 632.

When the sheet P has completely transported downward, the sheet P is then transported horizontally to a direction perpendicular to the sheet-transporting direction V following an almost circular arc with the side end of the sheet P being at the front. When the sheet P is horizontally transported, the second surface of the sheet P faces upward. It is to be noted that other components and operations of the duplex color printer 200 in this embodiment are identical to those of the duplex color printer 100 of the first embodiment so that the identical components are indicated by the same reference numbers, a detailed explanation of which will be omitted.

Thus, according to the duplex color printer 200 as the second embodiment, the first printer 1000, the sheet-reversing device 632 and the second printer 2000 are connected in series and the sheet-reversing device 632 includes the first linear sheet-transporting path L1 extending from the position p1 at which the reversed sheet P enters the first linear sheet-transporting path L1 to the position of the sheet-feeding inlet 603 of the second printer 2000.

The second printer 2000 has the correction portion 234 for correcting a deflection of the sheet P on which an image has been formed. The second printer 2000 includes the second linear sheet-transporting path L2 extending from the position of the sheet-feeding inlet 603 to the position p2 at which the deflection of the sheet P is corrected. On the assumption of this, a distance Lo between the positions p1 and p2 is set to be not smaller than the maximum length Lmax of the sheet P on a transporting direction thereof, the sheet P having the largest size among the sheets to be handled in the duplex color printer 200.

Similar to the first embodiment, such a configuration enables not only the sheet P to be delivered to the correction portion 234 in the second printer 2000 without any stresses but also the correction processing to be stable in the second printer 2000. Such a configuration also enables any precise control such as a synchronization of the transporting rollers 34 and the sheet ejection rollers 35 in the first printer 1000 when performing the correction processing to be made unnecessary. Such a configuration further enables a next sheet P to enter the sheet-transporting path to the second printer 2000 from the sheet-reversing device 63 while the correction portion 234 corrects the deflection of the sheet P, which prevents the sheets P from stopping moving, so that the productivity can be improved.

Further, according to the registration fluctuation processing, it is possible to shift the sheet P to the main scanning direction perpendicular to the sheet-transporting direction without any stresses to the sheet P. This prevents the duplex color printer 200 from being large-sized in the width and vertical directions thereof.

### Third Embodiment

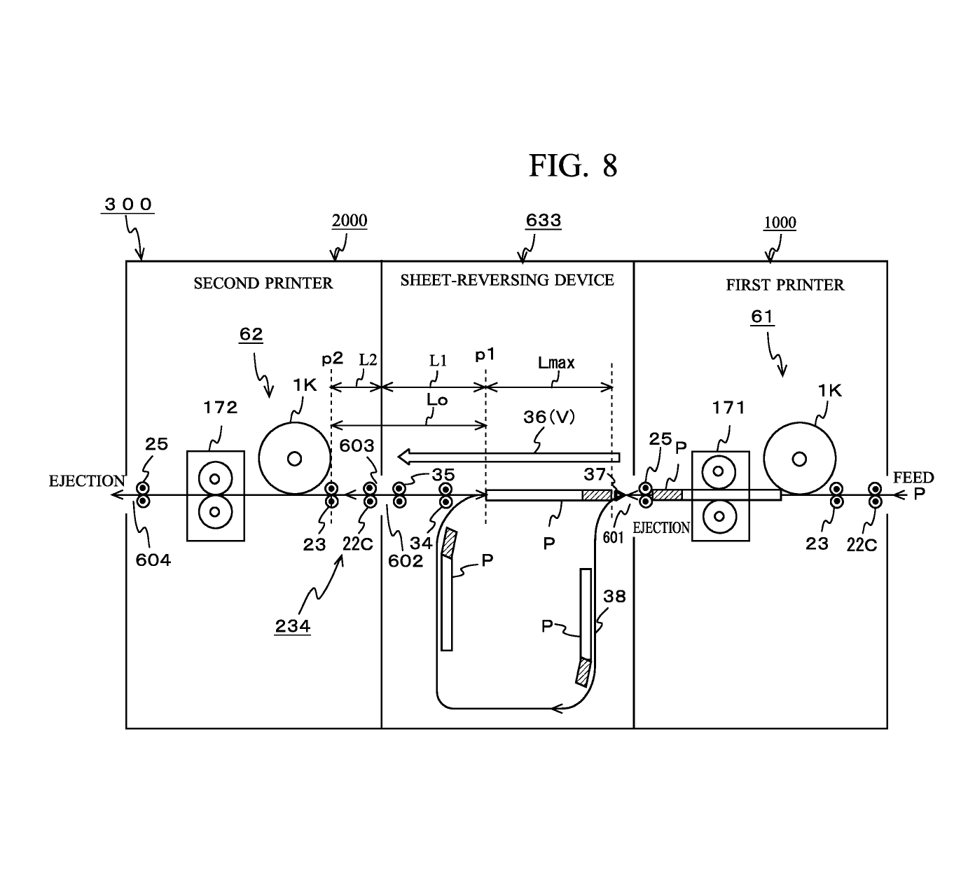

The following will describe a configuration example of a duplex color printer 300 according to a third embodiment of this invention with reference to FIG. 8. The third embodiment is different from the first and second embodiments in that a sheet-reversing device 633 of the switch-back system is provided below the straight transporting path 36 wherein the surface of the sheet P is reversed and the sheet P is upside down, namely, an orientation of the forward end or the rear end of the sheet P is changed. In the first printer 1000, the forward end of the sheet P is hit against the registration rollers 23 while in second printer 2000, the rear end of the sheet P is hit against the registration rollers 23.

The sheet-reversing device 633 of the switch-back system, which is shown in FIG. 8, is positioned between the first and second printers 1000, 2000 and is connected to each of them. The fixed sheet P ejected from the first printer 1000 is transported in a loop and the sheet-transporting direction of the sheet P is inverted on the straight transporting path 36 so that a surface of the sheet P is reversed. In other words, the sheet P on a first surface of which an image has been formed, falls down with the forward end of the sheet P being directed to a bottom of the sheet-reversing device 633 when the sheet P is introduced into the sheet-feeding inlet 601 of the sheet-reversing device 633. The sheet P is then transported in the loop.

When the sheet P has completely transported upward, the sheet P is then transported horizontally to a direction opposed to the sheet-transporting direction V. When the sheet P is horizontally transported, the first surface of the sheet P faces downward and the second surface of the sheet P faces upward. The sheet P is then transported to the sheet-transporting direction V on the first linear sheet-transporting path L1 to the second printer 2000 with the rear end of the sheet P being at the front. It is to be noted that other components and operations of the duplex color printer 300 in this embodiment are identical to those of the duplex color printer 100 or 200 of the first or second embodiment so that the identical components are indicated by the same reference numbers, a detailed explanation of which will be omitted.

Thus, according to the duplex color printer 300 as the third embodiment, the first printer 1000, the sheet-reversing device 633 and the second printer 2000 are connected in series and the sheet-reversing device 633 is configured to be the switch-back system in which the fixed sheet P is transported in a loop, the transporting direction thereof is inverted on the first linear sheet-transporting path L1 and the surface of the sheet P is reversed. The sheet-reversing device 633 includes the first linear sheet-transporting path L1 extending from the position p1 at which the reversed sheet P enters the first linear sheet-transporting path L1 to the position of the sheet-feeding inlet 603 of the second printer 2000.

The second printer 2000 has the correction portion 234 for correcting a deflection of the sheet P on which an image has been formed. The second printer 2000 includes the second linear sheet-transporting path L2 extending from the position of the sheet-feeding inlet 603 to the position p2 at which the deflection of the sheet P is corrected. On the assumption of this, a distance Lo between the positions p1 and p2 is set to be not smaller than the maximum length Lmax of the sheet P on a transporting direction thereof, the sheet P having the largest size among the sheets to be handled in the duplex color printer 300.

Similar to the first and second embodiments, such a configuration enables not only the sheet P to be delivered to the correction portion 234 in the second printer 2000 without any stresses but also the registration correction processing to be stable in the second printer 2000. Such a configuration also enables any precise control such as a synchronization of the transporting rollers 34 and the sheet ejection rollers 35 in the first printer 1000 when performing the registration correction processing to be made unnecessary. Such a configuration further enables a next sheet P to enter the sheet-transporting path to the second printer 2000 from the sheet-reversing device 633 while the correction portion 234 corrects the deflection of the sheet P, which prevents the sheets P from stopping moving, so that the productivity can be improved.

Further, according to the registration fluctuation processing, it is possible to shift the sheet P to the main scanning direction perpendicular to the sheet-transporting direction without any stresses to the sheet P. This prevents the duplex color printer 300 from being large-sized in the width and vertical directions thereof.

### Fourth Embodiment

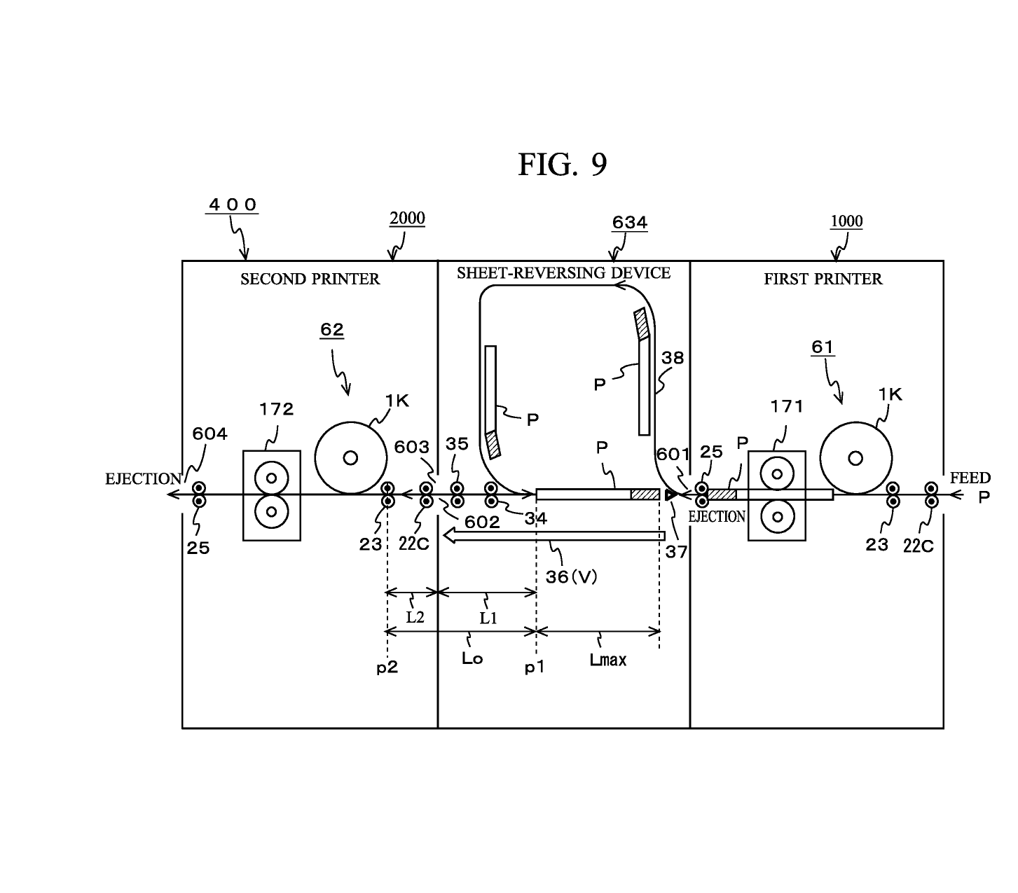

The following will describe a configuration example of a duplex color printer 400 according to a fourth embodiment of this invention with reference to FIG. 9. The fourth embodiment is different from the first through third embodiments in that a sheet-reversing device 634 of the switch-back system is provided above the straight transporting path 36 wherein the surface of the sheet P is reversed and the sheet P is upside down, namely, an orientation of the forward end or the rear end of the sheet P is changed. In the first printer 1000, the forward end of the sheet P is hit against the registration rollers 23 while in second printer 2000, the rear end of the sheet P is hit against the registration rollers 23.

As shown in FIG. 9, the sheet-reversing device 634 of the switch-back system is positioned between the first and second printers 1000, 2000 and is connected to each of them. The fixed sheet P ejected from the first printer 1000 is transported in a loop and the sheet-transporting direction of the sheet P is inverted on the straight transporting path 36 so that a surface of the sheet P is reversed. In other words, the sheet P on a first surface of which an image has been formed, rises upward with the forward end of the sheet P being directed to a top of the sheet-reversing device 634 when the sheet P is introduced into the sheet-feeding inlet 601 of the sheet-reversing device 634. The sheet P is then transported in the loop.

When the sheet P has completely transported downward, the sheet P is then transported horizontally to a direction opposed to the sheet-transporting direction V. When the sheet P is horizontally transported, the first surface of the sheet P faces downward and the second surface of the sheet P faces upward. Similar to the third embodiment, the sheet P is then transported to the sheet-transporting direction V on the first linear sheet-transporting path L1 to the second printer 2000 with the rear end of the sheet P being at the front. It is to be noted that other components and operations of the duplex color printer 400 in this embodiment are identical to those of the duplex color printer 100, 200 or 300 of the first, second or third embodiment so that the identical components are indicated by the same reference numbers, a detailed explanation of which will be omitted.

Thus, according to the duplex color printer 400 as the fourth embodiment, the first printer 1000, the sheet-reversing device 634 and the second printer 2000 are connected in series and the sheet-reversing device 634 is configured to be as the switch-back system in which the fixed sheet P is transported in a loop, the transporting direction thereof is inverted on the first linear sheet-transporting path L1 and the surface of the sheet P is reversed. The sheet-reversing device 634 includes the first linear sheet-transporting path L1 extending from the position p1 at which the reversed sheet P enters the first linear sheet-transporting path L to the position of the sheet-feeding inlet 603 of the second printer 2000, which is similar to the third embodiment.

The second printer 2000 has the correction portion 234 for correcting a deflection of the sheet P on which an image has been formed. The second printer 2000 includes the second linear sheet-transporting path L2 extending from the position of the sheet-feeding inlet 603 to the position p2 at which the deflection of the sheet P is corrected. On the assumption of this, a distance Lo between the positions p1 and p2 is set to be not smaller than the maximum length Lmax of the sheet P on a transporting direction thereof, the sheet P having the largest size among the sheets to be handled in the duplex color printer 400.

Similar to the first through third embodiments, such a configuration enables not only the sheet P to be delivered to the correction portion 234 in the second printer 2000 without any stresses but also the correction processing to be stable in the second printer 2000. Such a configuration also enables any precise control such as a synchronization of the transporting rollers 34 and the sheet ejection rollers 35 in the first printer 1000 when performing the correction processing to be made unnecessary. Such a configuration further enables a next sheet P to enter the sheet-transporting path to the second printer 2000 from the sheet-reversing device 634 while the correction portion 234 corrects the deflection of the sheet P, which prevents the sheets P from stopping moving, so that the productivity can be improved.

Further, according to the registration fluctuation processing, it is possible to shift the sheet P to the main scanning direction perpendicular to the sheet-transporting direction without any stresses to the sheet P. This prevents the duplex color printer 400 from being large-sized in the width and vertical directions thereof.

This invention is very suitably applicable to a duplex color printer, a duplex copy machine, a multiple function machine and the like, in which a sheet-reversing device is provided between an upstream printer and a downstream printer, and which are capable of forming an image on a surface of the sheet having a predetermined length, reversing the surface of the sheet and then, forming another image on the other surface of the sheet.

Although the present invention has been described with reference to the embodiments above, it is to be noted that the present invention is not limited to the embodiments, and various changes and modifications are possible to those who are skilled in the art insofar as they are within the scope of the invention.

It should be understood by those skilled in the art that various combinations, sub-combinations and alterations may occur depending on design requirements and other factors insofar as they are within the scope of the appended claims or the equivalents thereof.

What is claimed is:

1. An image forming apparatus comprising:
a first image forming section which forms a first image on a first surface of the sheet member;
a reversing section which reverses a surface of the sheet member on which the first image has been formed, the sheet member being ejected from the first image forming section;
a second image forming section which forms a second image on a second surface of the sheet member reversed by the reversing section;
a sheet-member-transporting path on which the sheet member, a surface of which is reversed, is transported from the reversing section to the second image forming section; and
a correction section which corrects a deflection of the sheet member before the second image is formed in the second image forming section, the correction section being positioned on the sheet-member-transporting path, wherein a distance between a position at which the sheet member enters the sheet-member-transporting path and a position at which the correction section corrects the deflection of the sheet member on the sheet-member-transporting path is set so as to be not smaller than a length of the sheet member on a transporting direction thereof, the sheet member having the largest size among the sheet members to be handled in the image forming apparatus.

2. The image forming apparatus according to claim 1 wherein the sheet-member-transporting path is formed in a straight line.

3. The image forming apparatus according to claim 1 wherein the first image forming section, the reversing section and the second image forming section are arranged in a straight line.

4. The image forming apparatus according to claim 1 wherein the reversing section reverses a surface of the sheet member ejected from the first image forming section without changing an orientation of a forward end of the sheet member.

5. The image forming apparatus according to claim 1 further comprises:
transporting rollers which transport the sheet member to the second image forming section with the sheet member being nipped, the transporting rollers being positioned on the sheet-member-transporting path; and
a control section which controls an operation of the transporting rollers, wherein when the correction section corrects the deflection of the sheet member, the control section controls the operation of the transporting rollers to follow a correct operation of the correction section or to release the nipping of the sheet member by the transporting rollers.
